(19) United States
(12) Patent Application Publication
(10) Pub. No.: US 2018/0023824 A1
(43) Pub. Date: Jan. 25, 2018

(54) LONG-RANGE NOZZLE FOR ENTRY OF AIR

(71) Applicant: Merlin Technology GmbH, Tumeltsham (AT)

(72) Inventor: Johann REISINGER, Pramet (AT)

(73) Assignee: Merlin Technology GmbH, Tumeltsham (AT)

(21) Appl. No.: 15/547,883

(22) PCT Filed: Feb. 11, 2016
(86) PCT No.: PCT/AT2016/050026

§ 371 Date: Aug. 1, 2017

(30) Foreign Application Priority Data
Feb. 13, 2015 (AT) A 50112/2015

(51) Int. Cl. F24F 6/14; B05B 7/00

(52) U.S. Cl. CPC F24F 6/14; B05B 7/0075; F24F 2006/143

(57) ABSTRACT

A long-range nozzle for introducing air into a room comprising a nozzle body (1) opening in a nozzle opening (13) is described. In order to enable an advantageous air moistening, it is proposed that the nozzle opening (13) is surrounded by a coaxial crown of atomizer nozzles (8) which are connected to an annular channel (9) to which pressurized liquid can be applied.

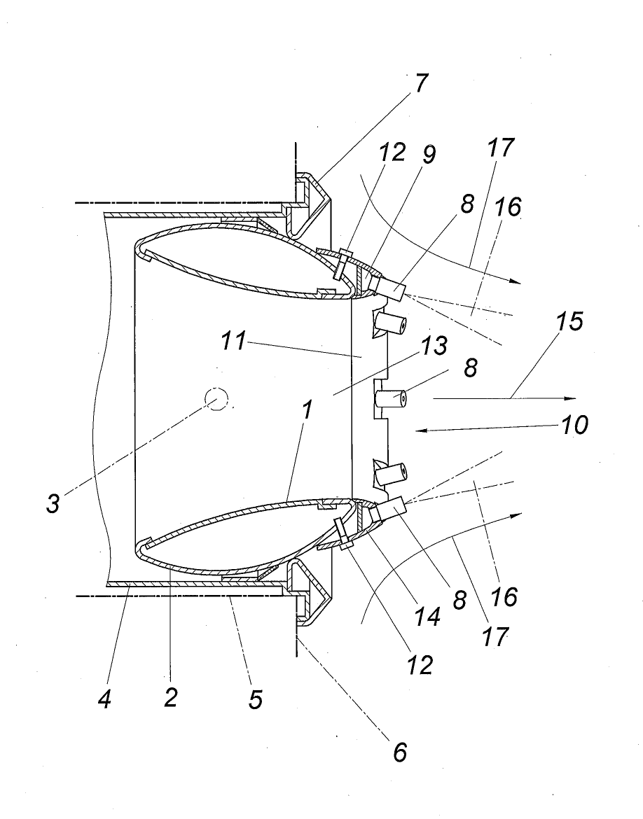

### 1. FIELD OF THE INVENTION

The invention relates to a long-range nozzle for introducing air into a room comprising a nozzle body which opens in a nozzle opening.

### 2. DESCRIPTION OF THE PRIOR ART

Long-range nozzles are used for introducing cold or warm air into rooms with a required depth of penetration of the blown-out air flow in order in particular to supply a specific room area with the introduced air. The alignment of the long-range nozzles therefore acquires a considerable importance which has resulted in pivotably adjustable nozzle bodies. For this purpose it is known (EP 0 826 932 A2) to provide the substantially conical nozzle body with a dome-shaped housing which is mounted pivotably adjustably in a tubular connecting piece on the one hand about the axis of the connecting piece and on the other hand about an axis perpendicular thereto so that the nozzle opening protruding beyond the dome-shaped housing can be arbitrarily aligned. If the blown-in air directed into the room is to have a predefined moisture content, the air upstream of the long-range nozzle must be appropriately adjusted which is not only expensive but usually excludes a subsequent fitting with a moistening device.

For cooling persons it is known (WO 95/35471 A1) to direct an air flow into which water is injected via nozzles onto persons to be cooled in the residence area in order one the one hand to withdraw heat of evaporation for the sprayed-in water droplets from the air flow and on the other hand to provide the residence area of the persons to be cooled with a moisture mist. The devices used for this purpose in which the nozzles are arranged along the outlet opening of a flow channel for the taken-in air to be cooled are therefore unsuitable for adjusting a predefined air humidity. Similar applies to other known cooling devices (US 2009/0072042 A1), in which a nozzle for spraying in water is provided coaxially to the outflow opening of the flow channel for the air flow to be cooled.

Finally for the large-area ventilation of sheds it is known (DE 33 43 731 A1) to connect a crown of radially outwardly opening nozzle channels for the blown-in air to a blow-in pipe provided in the shed ceiling, wherein it is possible to inject water into the radially emerging air flow in order to raise the air humidity. However, the distribution of the blown-in air into radial air flows conflicts with a long-range effect.

### SUMMARY OF THE INVENTION

It is therefore the object of the invention to provide measures with the aid of which it is possible to moisten the air dispensed via long-range nozzles in a simple manner without needing to fear any separation of non-evaporated liquid droplets from the air flow blown into the room.

Starting from a long-range nozzle of the type described initially, the invention solves the formulated object by a crown of atomizer nozzles coaxially surrounding the nozzle openings which are connected to an annular channel to which pressurized fluid can be applied.

By means of the atomizer nozzles, a liquid mist can be applied to the air jet blown out from the long-range nozzle which mixes with the conveying air flow and vaporizes. The injector effect of the long-range nozzle on the one hand and on the other hand of the crown of atomizer nozzles in this context causes the intake of an air jacket surrounding the liquid mist propagating in an annular manner from the atomizer nozzles which effectively prevents the separation of liquid droplets from the air flow blown into the space before the liquid droplets are vaporized. The turbulences occurring in the mixing zone on the one hand promote a rapid distribution of the liquid droplets inside the blown-out air flow and on the other hand increase the residence of the liquid droplets in the air flow so that an extensive vaporization of the liquid mist introduced via the atomizer nozzles arranged in a crown shape can already be determined at a comparatively short distance from the long-range nozzle. The supply of liquid at a predefined pressure to the atomizer nozzles is constructively simple via an annular channel and by controlling the pressure of the liquid to be atomized enables a good metering of the amount of liquid to be supplied depending on the difference between the desired humidity and the humidity of the air emerging from the long-range nozzle. In this case, the number of atomizer nozzles in the nozzle crown plays a subordinate role although a more rapid distribution of the moisture over the circumference of the air jet is achieved with a plurality of atomizer nozzles than for example with two atomizer nozzles. The liquid mist introduced into the air jet of the long-range nozzle can also be used for cooling the blown-in air flow because this liquid mist withdraws the heat of evaporation from the air for its vaporization.

Particularly simple constructional relationships are obtained if the nozzle body has a dome-shaped housing which carries the crown of atomizer nozzles because in this case no constructive modifications need be made to the nozzle body, and the dome-shaped housing provides sufficient space for accommodating the nozzle crown and the annular channel for acting upon the atomizer nozzles.

In order to improve the flow conditions for the air jacket surrounding the nozzle crown which is sucked in by an injector effect, an annular guiding wall can be provided on the side of the atomizer nozzles facing away from the nozzle opening which largely predefines the inflow conditions for this air jacket. If the atomizer nozzles are provided on a dome-shaped housing, a part of this housing can be advantageously used as guiding wall.

If the annular channel with the atomizer nozzles and optionally with the guiding wall forms a structural unit which can be placed on the dome-shaped housing, conventional long-range nozzles having a dome-shaped housing can be fitted in a simple manner with a device according to the invention for air moistening via a nozzle crown since the structural unit comprising the annular channel with the atomizer nozzles and optionally with the guiding wall merely needs to be fastened to the housing.

### BRIEF DESCRIPTION OF THE DRAWING

The subject matter of the invention is shown as an example in the drawing and specifically a long-range nozzle according to the invention is shown in a schematic longitudinal section.

### DESCRIPTION OF THE PREFERRED EMBODIMENT

According to the exemplary embodiment shown, the long-range nozzle according to the invention comprises a conventional nozzle body 1 with a dome-shaped housing 2 which is pivotably mounted about a pivot axis 3 in a pipe connecting piece 4. The pipe connecting piece 4 via which the long-range nozzle is connected to an air line, is inserted in a recess 5, indicated by a dot-dash line, of a wall or ceiling 6 delimiting a room to be ventilated. The pipe connecting piece 4 with the dome-shaped housing 2 mounted in the pipe connecting piece 4 is covered by a terminating ring 7 which overlaps the wall or ceiling 6.

Unlike conventional long-range nozzles of this type, the long-range nozzle according to the invention is provided with a crown of atomizer nozzles 8 coaxial to the nozzle body 1 which are connected to an annular channel 9 which can be acted upon with a pressurized liquid for moistening the air blown out into the room. The atomizer nozzles 8 with the annular channel 9 form a structural unit 10 which forms a ring 11 which can be placed on the dome-shaped housing 2. This ring 11 is firmly clamped onto the housing 2 with the aid of screws 12 and fluidically forms an extension of the nozzle opening 13 of the nozzle body 1. On the side of the atomizer nozzles 8 facing away from the nozzle opening 13, the ring 11 of the structural unit 10 forms a guiding wall 14.

In order to moisten the air flow 15 blown out into the room by the long-range nozzle, the atomizer nozzles 8 are acted upon with pressurized liquid so that a liquid mist 16 surrounding it is supplied to this air flow 15 from the atomizer nozzles 8 which is mixed internally with the air flow 15 emerging from the long-range nozzle and vaporizes during its conveyance with this air flow 15. As a result of the injector effect on the one hand of the air flow 15 blown out from the long-range nozzle and on the other hand of the liquid mist 16 ejected from the atomizer nozzles 8, room air 17 is additionally sucked in which surrounds the air flow 15 and the liquid mist 16 in the form of an air jacket and prevents liquid droplets of the liquid mist being separated from the air flow 15 before this liquid mist is vaporized.

1. A long-range nozzle for introducing air into a room comprising a nozzle body (1) opening in a nozzle opening (13), comprising a crown of atomizer nozzles (8) coaxially surrounding the nozzle opening (13) which are connected to an annular channel (9) to which pressurized liquid can be applied.

2. The long-range nozzle according to claim 1, wherein the nozzle body (1) comprises a dome-shaped housing (2) which carries the crown of atomizer nozzles (8).

3. The long-range nozzle according to claim 1, wherein an annular guiding wall (14) is provided on the side of the atomizer nozzles (8) facing away from the nozzle opening (13).

4. The long-range nozzle according to claim 1, wherein the annular channel (9) with the atomizer nozzles (8) and optionally with the guiding wall (14) forms a structural unit (10) which can be placed on the dome-shaped housing (2).
